(19) United States
(12) Patent Application Publication
(10) Pub. No.: US 2026/0030517 A1
(43) Pub. Date: Jan. 29, 2026

(54) EFFICIENT KNOWLEDGE GRAPH INDEXING AND RETRIEVAL

(71) Applicant: Salesforce, Inc., San Francisco, CA (US)

(72) Inventors: Yang ZHAO, Bellevue, WA (US); Ricky HO, San Francisco, CA (US); Prafulla Kumar CHOUBEY, Palo Alto, CA (US); Lik Phil Mui, San Francisco, CA (US); Chien-sheng WU, Palo Alto, CA (US); Frank WANG, San Francisco, CA (US); Xiangyu PENG, Palo Alto, CA (US)

(21) Appl. No.: 18/780,835

(22) Filed: Jul. 23, 2024

(51) Int. Cl. G06N 5/02

(52) U.S. Cl. CPC G06N 5/02

(57) ABSTRACT

Systems, devices, and techniques are disclosed for efficient knowledge graph indexing and retrieval. Document chunks may be generated from documents. Summarizations may be generated from document chunks. Entity types, entity properties, relations, and relation properties may be generated from a subset of the summarizations. A schema including entity types, entity properties, relations, and relation properties may be generated. Entity property triplets and entity relation triplets may be generated from the summarizations based on the schema and linked to the document chunks. A knowledge graph including nodes representing entities from the entity property triplets and entity relation triplets and edges representing the entity property triplets and the entity relation triplets may be generated. A search query may be received. Nodes and edges of the knowledge graph that include the entities, the entity property triplets and the entity relation triplets most similar to keywords of the search query may be determined.

### BACKGROUND

Building a knowledge graph from data extracted from documents may result in non-informative data being incorporated into the knowledge graph. The non-informative data incorporated into a knowledge graph may require more storage space while reducing the both the efficiency and effectiveness of retrieving data using the knowledge graph. Search queries to the knowledge graph may result in a more documents, or document chunks thereof, being returned than would be if the knowledge graph did not include the non-informative data. The returned documents, or document chunks, may also be overall less relevant to the search query due to the inclusion of documents or document chunks linked to the non-informative data in the knowledge graph.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for efficient knowledge graph indexing and retrieval according to an implementation of the disclosed subject matter.

FIG. 2 shows an example arrangement suitable for efficient knowledge graph indexing and retrieval according to an implementation of the disclosed subject matter.

FIG. 3 shows an example arrangement suitable for efficient knowledge graph indexing and retrieval according to an implementation of the disclosed subject matter.

FIG. 4 shows an example arrangement suitable for efficient knowledge graph indexing and retrieval according to an implementation of the disclosed subject matter.

FIG. 5 shows an example arrangement suitable for efficient knowledge graph indexing and retrieval according to an implementation of the disclosed subject matter.

FIG. 6 shows an example arrangement suitable for efficient knowledge graph indexing and retrieval according to an implementation of the disclosed subject matter.

FIG. 7 shows an example arrangement suitable for efficient knowledge graph indexing and retrieval according to an implementation of the disclosed subject matter.

FIG. 8 shows an example arrangement suitable for efficient knowledge graph indexing and retrieval according to an implementation of the disclosed subject matter.

FIG. 9 shows an example procedure suitable for efficient knowledge graph indexing and retrieval according to an implementation of the disclosed subject matter.

FIG. 10 shows an example procedure suitable for efficient knowledge graph indexing and retrieval according to an implementation of the disclosed subject matter.

FIG. 11 shows an example procedure suitable for efficient knowledge graph indexing and retrieval according to an implementation of the disclosed subject matter.

FIG. 12 shows a computer according to an implementation of the disclosed subject matter.

FIG. 13 shows a network configuration according to an implementation of the disclosed subject matter.

### DETAILED DESCRIPTION

Techniques disclosed herein enable efficient knowledge graph indexing and retrieval, which may allow for the generation of a knowledge graph from a group of documents and efficient retrieval from the knowledge graph. Documents chunks may be generated from a group of documents. Summarizations may be generated from the document chunks. Entity types, entity properties, relations, and relation properties may be determined from a subset of the summarizations. A schema including the entity types, entity properties, relations, and relation properties may be generated. Entity property triplets and entity relation triplets may be determined from the summarizations. The entity property triplets and entity relation triplets may be based on the schema and may be linked to the document chunks from which the summarizations, from which the entity property triplets and entity relation triplets were determined, were generated. A knowledge graph including nodes representing entities from the entity property triplets and entity relation triplets and edges representing the entity property triplets and entity relation triplets may be generated. A search query including keywords may be received number of nodes and edges of the knowledge graph that include entities, entity property triplets, and entity relation triplets most similar to the keywords of the search query may be determined. A number of document chunks based on frequency counts of the links from the entity property triplets and entity relation triplets to the document chunks linked to the entity property triplets and entity relation triplets most similar to the keywords of the search query may be determined. Relevant entity property triplets and entity relation triplets may be determined by traversing the knowledge graph to a specified depth starting at the nodes in the number of nodes and edges of the knowledge graph that include entities, entity property triplets and entity relation triplets most similar to the keywords of the search query. The document chunks of the determined number of document chunks and the relevant entity property triplets and entity relation triplets may be sent as a response to the received search query.

Documents chunks may be generated from a group of documents. The documents in the group of documents may include text in any suitable format. Any suitable form of document chunking may be used to generate document chunks from the documents in the group of documents, such as, for example, fixed size chunking including any suitable chunk length and overlap, recursive chunking, and semantic chunking. The document chunks may be generated from all of the documents in or a subset of documents from the group of documents. The subset of documents may include a suitable number of documents selected in a suitable manner to be a representative sample of the documents in the group of documents. A generated document chunk may be linked to the document from which it was generated such that any document chunk may be traced back to the document from which it was generated. The document chunks may be stored in a suitable storage device.

Summarizations may be generated from the document chunks. Any suitable form of summarization may be used on the document chunks to generate the summarizations, including, for example, any suitable form of natural language processing implemented using any suitable model, such as, for example, a large language model (LLM). The summarization may, for example, extract keywords or key-phrases from the document chunks. The summarization of a document chunk may be generated to include as much factual information from the document chunk as possible, up to all of the factual information in the document chunk. All of the document chunks may be summarized to generate the summarizations, and a summarization may be linked to the document chunk from which the summarization was generated. The summarizations may be stored in a suitable storage device.

Entity types, entity properties, relations, and relation properties may be determined from the summarizations. If all of the documents were used to generate document chunks, a subset of the generated summarizations may be used to determine entity types and entity properties for those entity types, and relations and relation properties for those relations. Otherwise, if only a subset of the documents were used to generate document chunks, all of the generated summarizations for that subset of the documents may be used to determine entity types, entity properties, relations, and relation properties. Entity types may include, for example, proper nouns and/or generic nouns that references entities and the entity properties may be properties that may be related to the entity types. For example, the entity types and entity properties may be {“name”: “freelance payment and management platform Kalo”, “type”: “Organization”}, {“name”: “Airbnb”, “type”: “Organization”}, {“name”: “Amazon”, “type”: “Organization”}, {“name”: “Walmart”, “type”: “Organization”}, {“name”: “40.4% of the U.S. workforce”, “type”: “Statistic”}, where “name” indicates a proper noun and “type” indicates a generic entity type that corresponds to the “name.” Entity properties for an entity of the type “business” may include “CEO”, “stock symbol”, and “headquarters.” Relations may include two entity types, a source entity and a target entity, that are considered to have a relation to each other and relation properties for a relation may provide context to the relation between the two entities. For example, a relation and its properties may be {“source”: “Illinois Department of Public Health (IDPH)”, “relation”: {“name”: “confirmed”, “properties”: {“year”: “2023”}}, “target”: “first three batches of mosquitoes positive for West Nile virus”}. The entity types, entity properties, relations, and relation properties may be determined from a subset of the summarizations may be determined using an LLM, for example, with the summarizations and a suitable prompt as input to the LLM.

A schema including the entity types, entity properties, relations, and relation properties may be generated. The schema may be generated in any suitable manner. For example, an LLM may be prompted to select important entity types, entity properties, relations, and relations properties from among the entity types, entity properties, relations, and relation properties determined from the summarizations. The important entity types, entity properties, relations, and relations properties selected by the LLM may be used as the schema. Heuristics may also be used to determine the most common, for example, most frequently occurring in the summarizations, entity types, entity properties, relations, and relations properties from among the entity types, entity properties, relations, and relation properties determined from the summarizations. The most common entity types, entity properties, relations, and relations properties may be used as the schema.

Entity property triplets and entity relation triplets may be determined from the summarizations. If all of the documents in the group of documents were not chunked and summarized before the schema was generated, the documents that were not chunked and summarized may be chunked and summarized in the same manner as the subset of documents that were chunked and summarized. This may result in summarizations for all of the documents in the group of documents. An LLM may be used to generate, from the summarizations, entities of the entity types in the schema and entity properties for the generated entities based on the entity properties in the schema, for example, using a prompt input to the LLM that includes the entity types and entity properties from the schema. The LLM may also be used to generate, from the summarizations, relations between entities the relation properties of those relations based on the relations and relation properties in schema, for example, using a prompt input to the LLM that includes the relation and relation properties from the schema. The generated entities and entity properties may be used to determine entity property triplets in the form of: (entity, entity property name, entity property value). The determined entity property triplets may be all possible entity property triplets that may be based on the entities and entity properties generated from the summarizations. The generated relations and relations properties may be used to determine entity relation triplets in the form of: (source entity, relation and its relation properties, target entity). The entity property triplets and entity relation triplets may be based on the schema and may be linked to the document chunks from which the summarizations, from which the entity property triplets and entity relation triplets were determined, were generated. An individual entity property triplet or entity relation triplet may be linked to any number of document chunks. For example, a single entity property triplet may be linked to multiple document chunks that each include the entity and entity properties used to form the single entity property triplet. A document chunk may be linked to any number of entity property triplets and entity relation triplets. The LLM may be used, using any suitable prompt, to select only informative and complete entity property triplets and entity relation triplets from among the determined entity property triplets and entity relation triplets.

A knowledge graph including nodes representing entities from the entity property triplets and entity relation triplets and edges representing the entity property triplets and entity relation triplets may be generated. The knowledge graph may be generated from any suitable subset of the entity property triplets and entity relation triplets selected in any suitable manner, for example, from only those entity property triplets and entity relation triplets that were selected by the LLM as being informative and complete. Nodes in the knowledge graph may represent entities from both the entity property triplets and entity relation triplets. The edges of the knowledge graph may represent the entity property triplets and entity relation triplets. An edge of the knowledge graph that connects two nodes may represent either an entity property triplet that includes both entities represented by the nodes or a entity relation triplet that includes the entity in the entity property triplet represented by a first of the two nodes and the entity in the entity property triplet represented by the second of the two nodes. The knowledge graph may index the document chunks to which the entity property triplets and entity relation triplets used to generate the knowledge graph are linked.

A search query including keywords may be received. The search query may be received in any suitable manner from any computing device. For example, the search query may be received as user input to a web page. The search query may be in the form of text. Keywords may be words extracted from the text of the search query.

A number of nodes and edges of the knowledge graph that include entities, entity triplets, and relation triplets most similar to the search query may be determined. Using any suitable technique, such as prompting an LLM, keywords may be extracted from the search query. The keywords in the search query may be compared to the entities represented by nodes in the knowledge graph. Search queries may also be compared to the entity property triplets and entity relation triplets represented by edges in the knowledge graph. Techniques such as string or word matching, embedding-similarity, or any other suitable form of comparison, may be used to determine a similarity between the search query and the entities, entity property triplets and entity relation triplets. The top-N entities and triplets, and their corresponding nodes and edges in the knowledge graph, most similar to the search query may be identified, where N may be any suitable number that may be less than the total number of nodes and edges in the knowledge graph.

A number of document chunks based on frequency counts of the number of times the document chunks are linked to the entities, entity property triplets and entity relation triplets most similar to the keywords of the search query may be determined. The document chunks that are linked to the top-N entities, entity property triplets and entity relation triplets corresponding to nodes and edges of the knowledge graph may have the frequency with which the document chunks are linked to any of the top-N entities, entity property triplets and entity relation triplets counted, resulting in a frequency count for each document chunk. The top-K document chunks with the highest frequency counts may be determined to be document chunks that are responsive to the search query, where K may be any suitable number that may be less than the total number of document chunks linked to the entities, entity property triplets, and entity relation triplets represented by nodes and edges of the knowledge graph.

Relevant entity property triplets and entity relation triplets may be determined by traversing the knowledge graph to a specified depth starting at the nodes in the number of nodes and edges of the knowledge graph that include entities most similar to the keywords of the search query. The knowledge graph may be traversed starting from each node that represent one of the entities in the top-N entities, entity property triplets, and entity relation triplets. The knowledge graph may be traversed to a suitable maximum depth that may be less than a depth that would result in traversing the entirety of the knowledge graph. During the traversal, all of the entity property triplets and entity relation triplets corresponding to traversed to traversed edges may be retrieved as candidate triplets, as they may be entity property triplets and entity relation triplets that have relevance to the search query due to their proximity in the knowledge graph to nodes that correspond to any of the entities in the top-N entities and triplets. An LLM may be used to select relevant entity property triplets and entity relation triplets from among the candidate entity property triplets and entity relation triplets. For example, a prompt that includes the candidate triplets and the search query may be input to the LLM, which may then select the candidate triplets considered most relevant to the search query.

The document chunks of the determined number of document chunks and the relevant entity property triplets and entity relation triplets may be sent as a response to the received search query. The top-K document chunks and the relevant entity property triplets and entity relation triplets may be returned as the results of the search query and sent to any suitable computing device or system. For example, the results of the search query may be returned to a web page to be displayed on a computing device that was used by a user to submit the search query.

Generating summarizations using the factual information in document chunks and selecting only informative and complete entity property triplets and entity relation triplets from among the determined entity property triplets and entity relation triplets may reduce memory requirement during generation of the knowledge graphs, as there may be fewer triplets to store and the dimensionality of the embedding may be reduced, reducing the memory needed to save the embedding. This may also improve the speed at which the knowledge graph is both generated and searched, increasing computational efficiency of the knowledge graph.

The use of storing reference from edges corresponding to entity property triplets and entity relation triplets in the knowledge graph to document chunks may improve disambiguation and avoid sub-optimal retrieval of search results from a knowledge graph, as the number of document chunks retrieved when responding to a search query may be reduced and more relevant document chunks may be retrieved. Retrieving fewer document chunks may and improve inference efficiency for the subsequent retrieval augmented generation (RAG) steps, as there may be fewer document chunks for reranking or for generating an answer.

The use of relation properties with entity relation triplets corresponding to edges in the knowledge graph may improve the quality of the triplet embeddings. This may ensure that document chunks that are relevant to a search query are ranked higher, allowing for search queries to be answered using fewer document chunks, improving inference speed and reducing the computation needed.

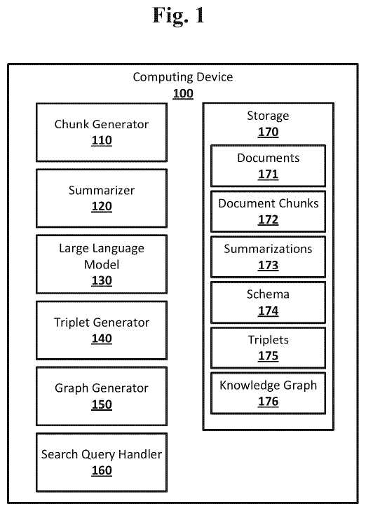

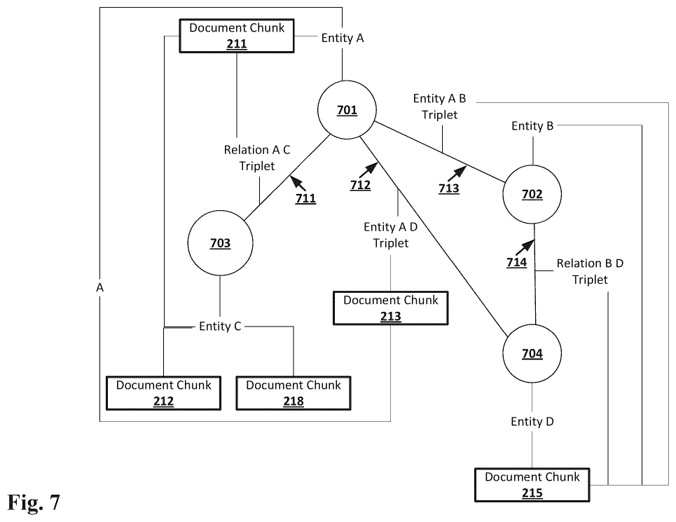

FIG. 1 shows an example system suitable for efficient knowledge graph indexing and retrieval according to an implementation of the disclosed subject matter. A computing device 100 may be, for example, the computer 20 as described in FIG. 7, or components thereof. The computing device 100 may include any number computing devices, each of which may include any suitable combination of central processing units (CPUs), graphical processing units (GPUs), and tensor processing units (TPUs). The computing device 100 may be distributed over any geographic area, and may, for example, include geographically disparate computing devices connected through any suitable network connections. The computing device 100 may be, or be a part of, a cloud computing server system that may support multi-tenancy.

The computing device 100 may include a chunk generator 110. The chunk generator 110 may be any suitable combination of hardware and software on the computing device 100 that may generate document chunks from documents by dividing documents, such as documents 171, into document chunks, such as document chunks 172. The chunk generator 110 may use any suitable form of document chunking, such as, for example, fixed size chunking including any suitable chunk length and overlap, recursive chunking, and semantic chunking. The chunk generator 110 may also link document chunks to the documents from which they were generated. Document chunks generated by the chunk generator 110 may be stored in any suitable storage, such as, for example, in a storage 170 of the computing device 100 as the document chunks 172.

The computing device 100 may include a summarizer 120. The summarizer 120 may be any suitable combination of hardware and software on the computing device 100 that may generate summarizations of document chunks, for example, summarizing the document chunks 172 to generate the summarizations 173. The summarizer 120 may use any suitable natural language processing implemented in any suitable manner to generate summarizations. The summarizer 120 may generate a summarization of a document chunk to include as much factual information from the document chunk as possible, up to all of the factual information in the document chunk. The summarizer 120 may also link summarizations to the document chunks from which they were generated. Summarizations generated by the summarizer 120 may be stored in any suitable storage, such as, for example, in a storage 170 of the computing device 100 as the summarizations 173.

The computing device 100 may include a large language model (LLM) 130. The LLM 130 may be any suitable combination of hardware and software on the computing device 100 for implementing a large language model that may be trained in any suitable manner to process natural language prompts and generate appropriate text output based on the prompts. The LLM 130 may generate entity types, entity properties, relations, and relation properties from summarizations, such as a subset of the summarizations 173. The LLM 130 may use the generated entity types, entity properties, relations, and relation properties to generate a schema, for example, schema 174, based on a prompt that requests that LLM 130 select the most important entity types, entity properties, relations, and relation properties from among the generated entity types, entity properties, relations, and relation properties. The schema 174 may be stored in any suitable storage, such as, for example, the storage 170.

The LLM 130 may generate entities and their properties, and relations and their properties, from the summarizations 173 based on the entity types, entity properties, relations, and relation properties in the schema 174. For example, the LLM 130 may be prompted with a prompt that includes the entity types and entity properties from the schema 174 along with the summarizations 173 to generate the entities and their properties and may be prompted with a prompt that includes the relations and relation properties from the schema 174 along with the summarizations 173 to generate relations and their properties. The LLM 130 may select to be stored as triplets 175 only informative and complete entity property triplets and entity relation triplets from among the entity property triplets and entity relation triplets determined by, for example, a triplet generator of the computing device 100. The LLM 130 may select relevant entity property triplets and entity relation triplets from among candidate triplets.

In some implementations, the schema 174 may be generated using heuristics, implemented in any suitable manner on the computing device 100, to determine the most common, for example, most frequently occurring in the summarizations 173, entity types, entity properties, relations, and relations properties from among the entity types, entity properties, relations, and relation properties generated by LLM 130 from the summarizations 173. The most common entity types, entity properties, relations, and relations properties may be used as the schema 174.

The computing device 100 may include triplet generator 140. The triplet generator 140 may be any suitable combination of hardware and software on the computing device 100 that may generate triplets, including entity property triplets and entity relation triplets, for example, generating triplets from the entities and entity properties and relations and relation properties generated by the LLM 130 to generate triplets from which the LLM 130 may select the triplets 175. The triplet generator 140 may generate triplets in any suitable manner, for example, generating entity property triplets in the form of: (entity, entity property name, entity property value) using the entities and entity properties generated from the summarizations 173 by the LLM 130 and generating entity relation triplets in the form of: (source entity, relation and its relation properties, target entity) using the relations and relation properties generated from the summarizations 173 by the LLM 130. The triplet generator 140 may link triplets selected by the LLM 130 and stored as the triplets 175 to document chunks from the document chunks 172 from which the summarizations 173, from which the entity property triplets and entity relation triplets were determined, were generated. Individual triplets of the triplets 175 may be linked to more than one of the document chunks 172. The triplets 175 may be stored in any suitable storage, such as, for example, the storage 170.

The computing device 100 may include graph generator 150. The graph generator 150 may be any suitable combination of hardware and software on the computing device 100 that may generate a knowledge graph, such as knowledge graph 176, from triplets, such as the triplets 175. The graph generator 150 may use the triplets 175 to generate the knowledge graph 176. Entities from the triplets 175 may be represented by nodes of the knowledge graph 176, with each unique entity represented by a single node. Entity property triplets and entity relation triplets from the triplets 175 may be represented by edges of the knowledge graph 176, with each unique entity property triplet and entity relation triplet represented by a single edge that may connect the nodes representing entities that include the two entities in an entity property triplet or the source entity and the target entity of the entity relation triplet. The nodes and edges of the knowledge graph 176 may serve as an index of the document chunks, from the document chunks 172, that are linked to the entities and the triplets 175 represented by the nodes and edges. The knowledge graph 176 may be stored in any suitable storage, such as, for example, the storage 176.

The computing device 100 may include search query handler 160. The search query handler 160 may be any suitable combination of hardware and software on the computing device 100 for receiving and providing a response to a search query. The search query handler 160 may receive a search query in any suitable form, such as, for example, text input by a user. The search query handler 160 may compare keywords in the search query to the entities represented by nodes in the knowledge graph 176 and the entity property triplets and entity relation triplets represented by edges in the knowledge 176 graph using, for example, keyword search, embedding-similarity, or any other suitable form of comparison, that may be used to determine a similarity between the keywords of the search query and the entities, entity property triplets, and entity relation triplets. The top-N entities, entity property triplets, and entity relation triplets, and their corresponding nodes and edges in the knowledge graph 176, most similar to the keywords from the search query may be identified, where N may be any suitable number that may be less than the total number of nodes and edges in the knowledge graph 176. The search query handler 160 may generate frequency counts for the document chunks by counting the number of times document chunks from the document chunks 172 that are linked to the top-N entities, entity property triplets, and entity relation triplets corresponding to nodes and edges of the knowledge graph 176 are linked to the top-N entities, entity property triplets, and entity relation triplets. The search query handler 160 may select a top-K document chunks with the highest frequency counts as responsive to the search query, where K may be any suitable number that may be less than the total number of document chunks linked to nodes and edges of the knowledge graph 176. The search query handler 160 may also traverse the knowledge graph 176 starting at the nodes that represent entities from the top-N entities and triplets to a specified maximum depth and may input any entity property triplets and entity relation triplets encountered during this traversal to the LLM 130 as candidate triplets. The LLM 130 may be prompted to select triplets that are relevant to the search query from among the candidate triplets. The search query handler 160 may return the top-K document chunks and the relevant triplets identified by the LLM 130 as a response to the search query.

The storage 170 may be any suitable combination of hardware and software for storing data on any suitable physical storage mediums that may be part of or accessible to the computing device 100, including local storage and storage accessible over wired or wireless connections including network connections. The storage 170 may store the documents 171, the document chunks 172, the summarizations 173, the schema 174, the triplets 175, and the knowledge graph 176.

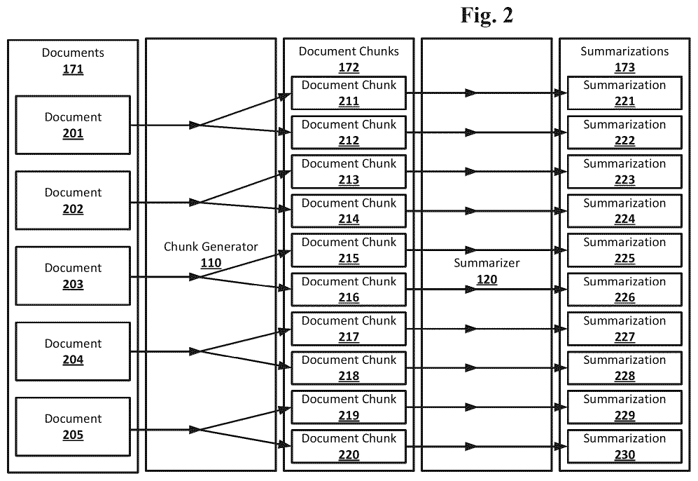

FIG. 2 shows an example arrangement suitable for efficient knowledge graph indexing and retrieval according to an implementation of the disclosed subject matter. The documents 171 may include a document 201, document 202, document 203, document 204, and document 205. The documents 201-205 may be input to the chunk generator 110. The chunk generator 110 may chunk the documents 201-205 to generate, for example, document chunks 213 and 214 from the document 202, document chunks 215 and 216 from the document 203, document chunks 217 and 218 from the document 204, and document chunks 219 and 220 from the document 205. The document chunks 211-220 may be stored with the document chunks 172. The document chunks 211-220 may be input to the summarizer 120. The summarizer 120 may generate summarizations, for example, summarization 221 from the document chunk 211, summarization 222 from the document chunk 212, summarization 223 from the document chunk 213, summarization 224 from the document chunk 214, summarization 225 from the document chunk 215, summarization 226 from the document chunk 216, summarization 227 from the document chunk 217, summarization 228 from the document chunk 218, summarization 229 from the document chunk 219, and summarization 230 from the document chunk 220, by extracting factual information from the document chunks 211-220.

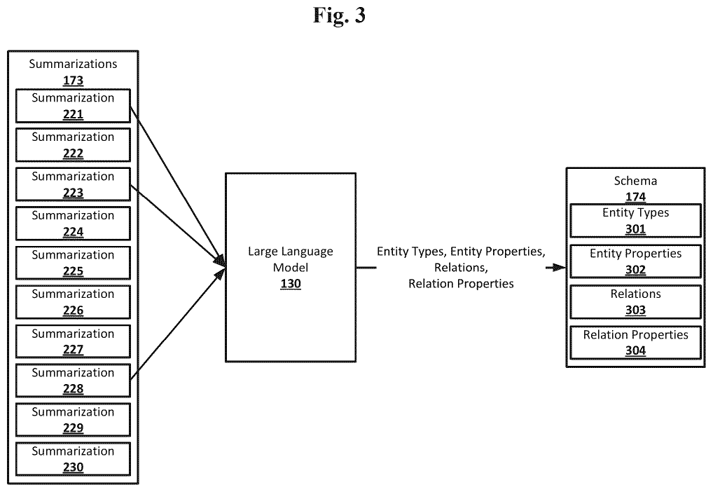

FIG. 3 shows an example arrangement suitable for efficient knowledge graph indexing and retrieval according to an implementation of the disclosed subject matter. The LLM 130 may generate the schema 174 using a subset of the summarizations 221-230, or all of the summarizations 221-230 if the documents 201-205 are a subset that is less than all of the documents 171. For example, the LLM 130 may generate entity types, entity properties, relations, and relation properties from the 221, 223, and 228, which may be selected as a representative subset of the summarizations 221-230. The LLM 130 may then use the generated entity types, entity properties, relations, and relation properties to generate the schema 174 based on a prompt that requests that LLM 130 select the most important entity types, entity properties, relations, and relation properties from among the generated entity types, entity properties, relations, and relation properties, or based on the use of heuristics to determine the most common, for example, most frequently occurring in the summarizations 221, 223, and 228, entity types, entity properties, relations, and relations properties from among the entity types, entity properties, relations, and relation properties generated by LLM 130 from the summarizations 221, 223, and 228. The schema 174 may include the selected entity types 301, entity properties 302, relations 303, and relation properties 304.

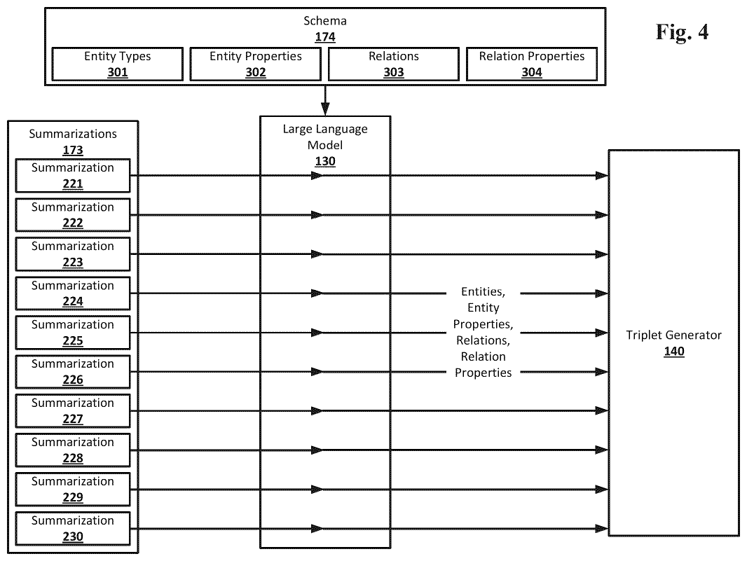

FIG. 4 shows an example arrangement suitable for efficient knowledge graph indexing and retrieval according to an implementation of the disclosed subject matter. The LLM 130 may generate entities and their properties, and relations and their properties, from all of the summarizations 221-230 based on the entity types, entity properties, relations, and relation properties in the schema 174 that was generated from the summarizations 221, 223, and 228. The LLM 130 may be prompted with a prompt that includes the entity types 301 and entity properties 302 from the schema 174 along with the summarizations 221-230 to generate the entities and their properties and may be prompted with a prompt that includes the relations 303 and relation properties 304 from the schema 174 along with the summarizations 221-230 to generate relations and their properties. The entities, entity properties, relations, and relation properties may be generated per summarization. For example, the LLM 130 may generate entities, entity properties, relations, and relation properties separately for the summarization 221 and the summarization 222, and may link generated entities, entity properties, relations, and relation properties to the summarization from which they were generated, through which they may be linked to the document chunk from which the summarization was generated. For example, entities, entity properties, relations, and relation properties generated from the summarization 221 may be linked to the summarization 221 and to the document chunk 211 or may be linked directly to the document chunk 211. The entities, entity properties, relations, and relation properties generated by the LLM 130 from the summarizations 221-230 may be input to the triplet generator 140.

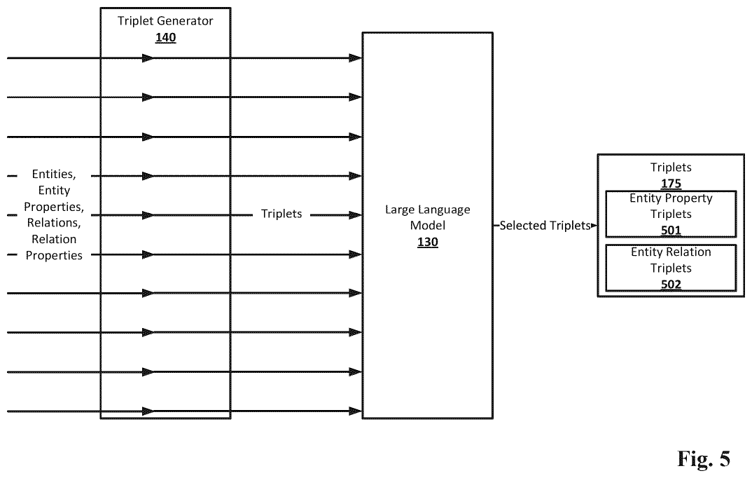

FIG. 5 shows an example arrangement suitable for efficient knowledge graph indexing and retrieval according to an implementation of the disclosed subject matter. The triplet generator 140 may receive the entities, entity properties, relations, and relation properties output by the LLM 130 and use them to generate entity property triplets in the form of: (entity, entity property name, entity property value) and entity relation triplets in the form of: (source entity, relation and its relation properties, target entity). The triplet generator 140 may generate triplets on a per-summarization basis, for example, separately generating triplets based on entities, entity properties, relations, and relation properties generated from the summarization 221 and the summarization 222. This may allow the triplets to be linked back to the summarization from which they were generated, and to the document chunk from which that summarization was generated. For example, a triplet generated from entities, entity properties, relations, and relation properties generated from the summarization 221 may be linked to the summarization 221 and to the document chunk 211.

The LLM 130 may receive the triplets output by the triplet generator 140 and may select only informative and complete entity property triplets to be stored as entity property triplets 501 of the triplets 175 and may select from among the entity property triplets and entity relation triplets generated by the triplet generator 140 only informative and complete entity relation triplets to be stored as entity relation triplets 502 of the triplets 175. The triplet generator 140 may link triplets selected by the LLM 130 and stored as the entity property triplets 501 and the entity relation triplets 502 to document chunks from the document chunks 172 from which were generated the summarizations 173 from which the entity property triplets and entity relation triplets were generated. Individual triplets of the triplets 175 may be linked to more than one of the document chunks 172. For example, a single entity property triplet may be linked to both the document chunk 221 and the document chunk 227. A document chunk may be linked to any number of the triplets 175.

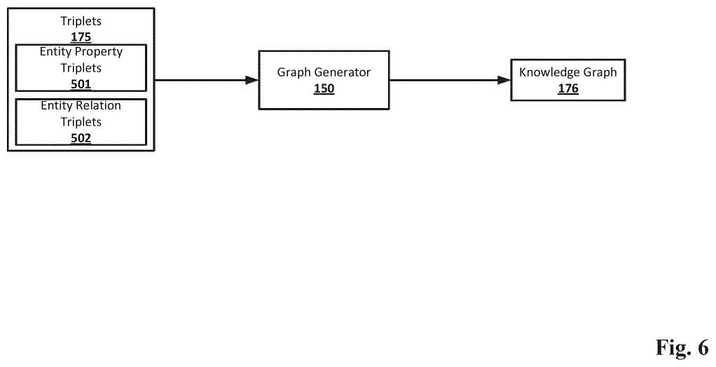

FIG. 6 shows an example arrangement suitable for efficient knowledge graph indexing and retrieval according to an implementation of the disclosed subject matter. The graph generator 150 may receive the triplets 175, including the entity property triplets 501 and the entity relation triplets 502. The graph generator 150 may use the triplets 175 to generate the knowledge graph 176. Entities from the entity property triplets 501 and the entity relation triplets 502 may be represented by nodes of the knowledge graph 176, with each unique entity represented by a single node. The entity property triplets 501 and entity relation triplets 502 may be represented by edges of the knowledge graph 176, with each unique entity property triplet and entity relation triplet represented by a single edge that may connect the nodes representing the entities in an entity property triplet or the source entity and the target entity of a entity relation triplet. The nodes and edges of the knowledge graph 176 may serve as an index of the document chunks 211-220 that are linked to the entities, entity property triplets 501, and the entity relation triplets 502 that are represented by the nodes and edges.

FIG. 7 shows an example arrangement suitable for efficient knowledge graph indexing and retrieval according to an implementation of the disclosed subject matter. A portion of the knowledge graph 176 may include, for example, four nodes 701, 702, 703, and 704, connected by four edges 711, 712, 713, and 714. The node 701 may represent an entity A that may be from triplets linked to the document chunks 211 and 213. The node 702 may represent an entity B that may be from triplets linked to the document chunk 215. The node 703 may represent an entity C that may be from triplets linked to the document chunks 211, 212, and 218. The node 704 may represent an entity D that may be from triplet linked to the document chunk 215. The edge 711 may connect the nodes 701 and 703 and represent an entity property triplet that may include entity A and entity C and be linked to the document chunk 211. The edge 712 may connect the nodes 701 and 704 and may represent a entity relation triplet that may have a source entity of entity A and a target entity of entity D and be linked to the document chunk 213. The edge 713 may connect the nodes 701 and 702 and may represent an entity property triplet that may include the entity A and the entity B and be linked to the document chunk 215. The edge 714 may connect the nodes 702 and 704 and may represent a entity relation triplet that may have a source entity of entity B and a target entity of entity D and may be linked to the document chunk 215. The linking of the entities and triplets represented by the nodes 701-704 and the edges 711-714 to document chunks 211, 212, 213, 215, and 218 may allow the portion of the knowledge graph 176 to serve as an index of the document chunks 211, 212, 213, 215, and 218. The entirety of the knowledge graph 176 may serve as an index of the document chunks 211-220.

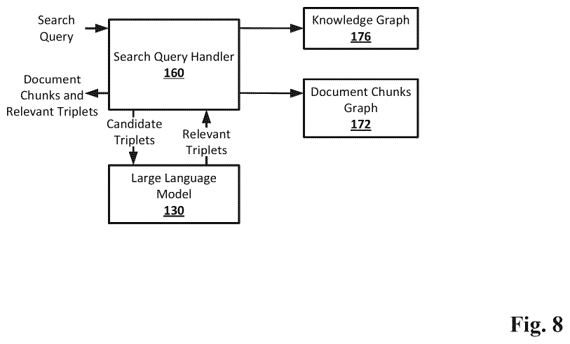

FIG. 8 shows an example arrangement suitable for efficient knowledge graph indexing and retrieval according to an implementation of the disclosed subject matter. The search query handler 160 may receive a search query. The search query may be received from a computing device belonging to a user who input the search query as text. The search query handler 160 may compare keywords in the search query to the entities from the entity property triplets 501 and entity relation triplets 502 represented by nodes in the knowledge graph 176 and to the entity property triplets 501 and the entity relation triplets 502 represented by edges in the knowledge 176 graph using, for example, keyword search, embedding-similarity, or any other suitable form of comparison, that may be used to determine a similarity between the keywords of the search query and entities, the entity property triplets 501, and entity relation triplets 502. For example, the search query handler 160 may compare keywords from the search query to the entities A, B, C, and D represented by the nodes 701-704 and to the entity property triplets and the entity relation triplets represented by the edges 711-714. The top-N entities and triplets corresponding to nodes and edges in the knowledge graph 176 that are most similar to the keywords from the search query may be identified, where N may be any suitable number that may be less than the total number of nodes and edges in the knowledge graph 176. The search query handler 160 may generate frequency counts for the document chunks by counting the number of times document chunks from the document chunks 172 that are linked to the top-N entities, entity property triplets, and entity relation triplets corresponding to nodes and edges of the knowledge graph 176 are linked to the top-N entities, entity property triplets, and entity relation triplets. For example, if the entity A, corresponding to the node 701, is one of the top-N entities and triplets most similar to keywords from the search query, the search query handler 160 may perform a frequency count to determine how many times the documents chunks 211 and 213 are linked to any of the top-N entities, entity property triplets, and entity relation triplets. The search query handler 160 may select a top-K document chunks with the highest frequency counts as responsive to the search query, where K may be any suitable number that may be less than the total number of document chunks linked to nodes and edges of the knowledge graph 176. For example, if the document chunk 211 is one of the top-K document chunks based on frequency count, the document chunk 211 may be selected to be returned as part of the results in response to the search query. The search query handler 160 may also traverse the knowledge graph 176 starting at the nodes that represent entities from the top-N entities and triplets to a specified maximum depth and may input any entity property triplets and entity relation triplets encountered during this traversal to the LLM 130 as candidate triplets. The LLM 130 may be prompted to select triplets that are relevant to the search query from among the candidate triplets. The search query handler 160 may return the top-K document chunks and the relevant triplets identified by the LLM 130 as a response to the search query.

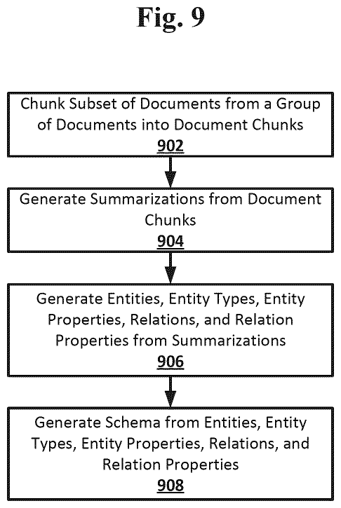

FIG. 9 shows an example procedure suitable for efficient knowledge graph indexing and retrieval according to an implementation of the disclosed subject matter. At 902, a subset of documents from a group of documents may be chunked into document chunks. For example, a subset of the documents 171 may be chunked by the chunk generator 110 to generate document chunks that may be stored in the document chunks 172. Only a subset of the documents 171, less than all of the documents 171, may need to be chunked during the generation of a schema.

At 904, summarizations may be generated from document chunks. For example, the summarizer 120 may summarize the document chunks generated by chunking the subset of the documents 171 to generate summarizations that may be stored in the summarizations 173. The summarization of a document chunk may include as much factual information from the document chunk as possible, up to all of the factual information in the document chunk.

At 906, entities, entity types, entity properties, relations, and relation properties may be generated from summarizations. For example, the LLM 130 may generate entity types, entity properties, relations, and relation properties from the summarizations 173 that were generated from the document chunks 172 that were generated from the subset of the documents 171.

At 908, a schema may be generated from entities, entity types, entity properties, relations, and relation properties. For example, the LLM 130 may generate the schema 174 from the generated entity types, entity properties, relations, and relation properties by being prompted to select important entity types, entity properties, relations, and relations properties from among the entity types, entity properties, relations, and relation properties to be used in the schema 174. In some implementations, heuristics may be used to determine the most common, for example, most frequently occurring in the summarizations, entity types, entity properties, relations, and relations properties from among the entity types, entity properties, relations, and relation properties generated from the summarizations. The most common entity types, entity properties, relations, and relations properties may be used as the schema 174.

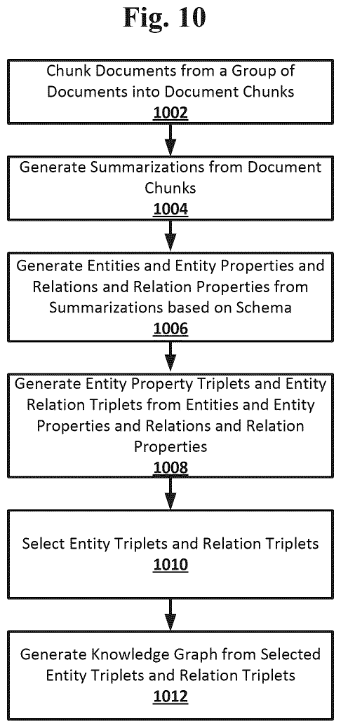

FIG. 10 shows an example procedure suitable for efficient knowledge graph indexing and retrieval according to an implementation of the disclosed subject matter. At 1002, the documents from a group of documents may be chunked into document chunks. For example, the documents 171 may be chunked by the chunk generator 110 to generate document chunks that may be stored in the document chunks 172. Documents of the documents 171 that may have already been chunked during generation of a schema, such as the schema 174, may not need to be chunked again. In some implementations, all of the documents in the documents 171 may have been chunked during generation of the schema 174.

At 1004, summarizations may be generated from document chunks. For example, the summarizer 120 may summarize the document chunks generated by chunking the documents 171 to generate summarizations that may be stored in the summarizations 173. The summarization of a document chunk may include as much factual information from the document chunk as possible, up to all of the factual information in the document chunk. Document chunks that may have already been summarized during generation of a schema, such as the schema 174, may not need to be summarized again.

At 1006, entities, entity types, entity properties, relations, and relation properties may be generated from summarizations based on the schema. For example, the LLM 130 may, using a prompt that includes the schema 174, generate from the summarizations 173 entities of the entity types in the schema 174, entity properties for the generated entities based on the entity properties in the schema 174 and relations between generated entities and their relation properties based on the relations and relation properties in schema 174.

At 1008, entity property triplets and entity relation triplets may be generated from the entities, entity properties, relations, and relation properties. For example, the triplet generator 140 may generate triplets, including entity property triplets in the form of: (entity, entity property name, entity property value) and entity relation triplets in the form of (source entity, relation and its relation properties, target entity), from the entities, entity properties, relations, and relation properties generated by the LLM 130. The entity property triplets and entity relation triplets may be generated on a per document chunk basis. A triplet may be linked to the document chunk form whose summarization the entity and entity property or relation and relation property in the triplet was generated.

At 1010, entity property triplets and entity relation triplets may be selected. For example, the LLM 130 may select from among the triplets generated by the triplet generator 140 the triplets that are informative and complete entity property triplets and entity relation triplets. The selected entity property triplets and entity relation triplets may be stored as the entity property triplets 501 and the entity relation triplets 502 in the triplets 175.

At 1012, a knowledge graph may be generated from the selected entity property triplets and entity relation triplets. For example, the knowledge graph generator 160 may generate the knowledge graph 176 using the entity property triplets 501 and entity relation triplets 502 from the triplets 175, including nodes representing entity property triplets and edges representing entity relation triplets may be generated. Each of the entities from the entity property triplets 501 and entity relation triplets 502 may be represented by a node in the knowledge graph 176. The edges of the knowledge graph 176 may represent the entity property triplets 501 and the entity relation triplets 502. An edge of the knowledge graph 176 that connects two nodes may represent an entity property triplet that includes the entities of the two nodes or a entity relation triplet that includes the entity in the entity represented by a first of the two nodes and the entity represented by the second of the two nodes. The nodes and edges of the knowledge graph 176 may be linked to the same document chunks that the entities, entity property triplets, and entity relation triplets that the nodes and edges represent are linked to.

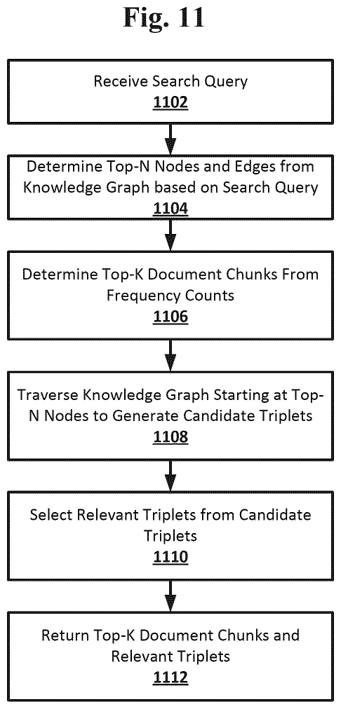

FIG. 11 shows an example procedure suitable for efficient knowledge graph indexing and retrieval according to an implementation of the disclosed subject matter. At 1102, a search query may be received. For example, the search query handler 160 may receive a search query, which may be in the form of text, from any suitable source. The search query may, for example, have been entered by a user on a user computing device and sent to the computing device 100.

At 1104, a top-N nodes and edges from the knowledge graph may be determined based on the search query. For example, the search query handler 160 may compare keywords from the search query to the entity property triplets and entity relation triplets represented by nodes in the knowledge graph 176 using, for example, embedding-similarity, or any other suitable form of comparison. The keywords may be determined using, for example, the LLM 130. The top-N entities, entity property triplets, and entity relation triplets, and their corresponding nodes and edges in the knowledge graph 176, most similar to the keywords from the search query may be identified, where N may be any suitable number that may be less than the total number of nodes and edges in the knowledge graph. The search query handler 160 may determine the top-N nodes and edges as the nodes and edges of the knowledge graph 176 that represent the top-N entities, entity property triplets, and entity relation triplets most similar to the keywords from the search query.

At 1106, a top-K document chunks may be determined from frequency counts. For example, the search query handler 160 may generate frequency counts for the document chunks by counting the number of times document chunks from the document chunks 172 that are linked to the top-N entities, entity property triplets, and entity relation triplets corresponding to nodes and edges of the knowledge graph 176 are linked to the top-N entities, entity property triplets, and entity relation triplets. The frequency counts may be performed per-document chunk. The top-K document chunks with the highest frequency counts may be determined to be document chunks that are responsive to the search query, where K may be any suitable number that may be less than the total number of document chunks linked to nodes and edges of the knowledge graph 176.

At 1108, the knowledge graph may be traversed starting at top-N nodes to generate candidate triplets. For example, the search query handler 160 may traverse the knowledge graph 176 to a specified maximum depth starting from any nodes that are part of the top-N nodes and edges. The search query handler 160 may generate candidate triplets, which may be any triplets represented by nodes and edges traversed during the traversal of the knowledge graph that starts at the nodes in the top-N nodes and edges and goes to the specified maximum depth.

At 1110, relevant triplets may be selected from the candidate triplets. For example, the candidate triplets may be used as input to the LLM 130 with a prompt that includes the search query and requests that the LLM 130 select triplets from among the candidate triplets that are most relevant to the search query. The LLM 130 may than select relevant triplets from among the candidate triplets.

At 1112, the top-K document chunks and relevant triplets may be returned. For example, the search query handler 160 may return the top-K document chunks and the relevant triplets as search results in response to the search query. The search results may be returned to, for example, the user computing device from which the search query was received, or to any other suitable destination, including any other suitable computing device.

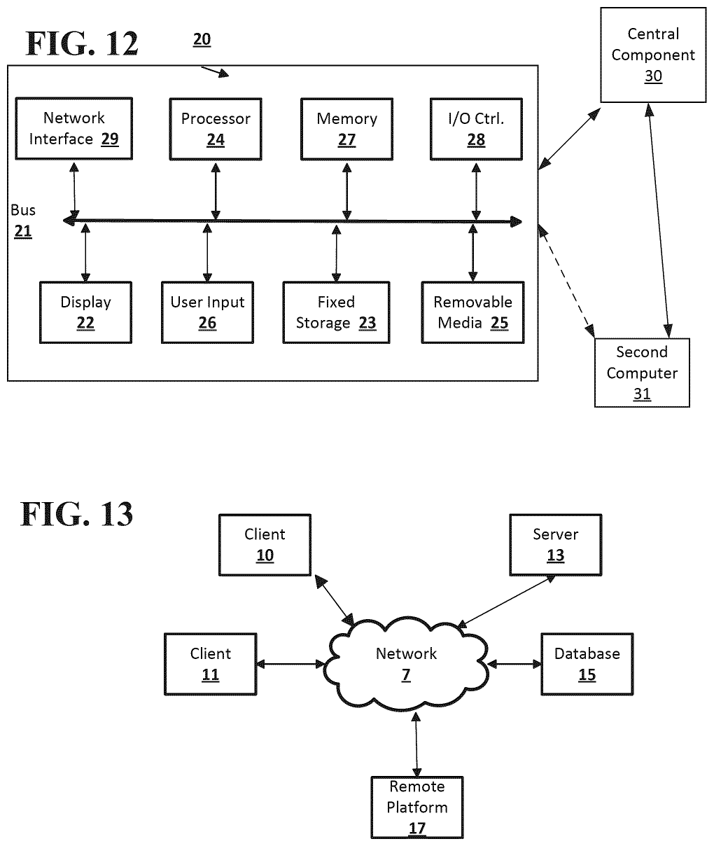

Implementations of the presently disclosed subject matter may be implemented in and used with a variety of component and network architectures. FIG. 12 is an example computer 20 suitable for implementing implementations of the presently disclosed subject matter. As discussed in further detail herein, the computer 20 may be a single computer in a network of multiple computers. As shown in FIG. 12, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 13.

Many other devices or components (not shown) may be connected in a similar manner (e.g., document scanners, digital cameras and so on). Conversely, all of the components shown in FIG. 12 need not be present to practice the present disclosure. The components can be interconnected in different ways from that shown. The operation of a computer such as that shown in FIG. 12 is readily known in the art and is not discussed in detail in this application. Code to implement the present disclosure can be stored in computer-readable storage media such as one or more of the memory 27, fixed storage 23, removable media 25, or on a remote storage location.

FIG. 13 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
generating, by a computing device, document chunks from a group of documents;
generating, by the computing device, summarizations from the document chunks;
generating, by the computing device, entity types, entity properties, relations, and relation properties from a subset of the summarizations;
generating, by the computing device a schema comprising the entity types, entity properties, relations, and relation properties;
generating, by the computing device, entity property triplets and entity relation triplets from the summarizations, wherein the entity property triplets and entity relation triplets are based on the schema and are linked to the document chunks from which the summarizations, from which the entity property triplets and the entity relation triplets were determined, were generated;
generating, by the computing device, a knowledge graph comprising nodes representing entities from the entity property triplets and entity relation triplets and edges representing the entity property triplets and the entity relation triplets;
receiving, by the computing device, a search query comprising keywords;
determining, by the computing device, nodes and edges of the knowledge graph that comprise the entities, the entity property triplets and the entity relation triplets most similar to the keywords of the search query;
determining, by the computing device, document chunks based on frequency counts of the number of times the document chunks are linked to the entities, entity property triplets, and relations triplets corresponding to the determined nodes and edges;
determining, by the computing device, relevant entity property triplets and entity relation triplets by traversing the knowledge graph to a specified depth starting at the nodes in the determined nodes and edges; and
sending, by the computing device, the determined document chunks and the relevant entity property triplets and entity relation triplets as a response to the received search query.

2. The method of claim 1, wherein an entity property triplet is linked to two or more document chunks, wherein a entity relation triplet is linked to two or more document chunks, and wherein an entity is linked to two or more document chunks.

3. The method of claim 1, wherein an edge representing one of the entity relation triplets connects two nodes representing entities wherein a first of the two nodes represents a source entity of the one of the entity relation triplets and a second of the two nodes represent a target entity of the one of the entity relation triplets.

4. The computer-implemented method of claim 1, wherein generating, by the computing device a schema comprising the entity types, entity properties, relations, and relation properties further comprises either selecting, with a large language model, from among the entity types, entity properties, relations and relation properties or using heuristics to select the most common of the entity types, entity properties, relations, and relation properties.

5. The computer-implemented method of claim 1, wherein determining, by the computing device, entity property triplets and entity relation triplets from the summarizations, wherein the entity property triplets and entity relation triplets are based on the schema and are linked to the document chunks from which the summarizations, from which the entity property triplets and entity relation triplets were determined, were generated further comprises:
determining, with a large language model, entities, entity properties for the entities, relations, and relation properties for the relations from the summarizations;
generating possible entity property triplets from the entities and entity properties for the entities;
generating possible entity relation triplets from the relations and relation properties for the relations; and
selecting, using the large language model, complete possible entity property triplets to be the entity property triplets and complete possible entity relation triplets to be the entity relation triplets.

6. The computer-implemented method of claim 1, wherein the determined nodes and edges comprise N nodes and edges wherein N is a number less than total number of nodes and edges of the knowledge graph, and wherein the determined document chunks comprise K document chunks wherein K is a number less than the total number of the document chunks.

7. The computer-implemented method of claim 1, wherein determining, by the computing device, relevant entity property triplets and entity relation triplets by traversing the knowledge graph to a specified depth starting at the nodes in the determined nodes and edges further comprises:
determining candidate triplets based on any entity property triplets and relations triplets represented by edges encountered during traversal of the knowledge graph; and
selecting, with a large language model, the relevant entity property triplets and entity relation triplets from among the candidate triplets.

8. A computer-implemented system comprising:
a storage comprising transaction state data; and
a processor that generates document chunks from a group of documents,
generates summarizations from the document chunks,
generates entity types, entity properties, relations, and relation properties from a subset of the summarizations,
generates a schema comprising the entity types, entity properties, relations, and relation properties,
generates entity property triplets and entity relation triplets from the summarizations, wherein the entity property triplets and entity relation triplets are based on the schema and are linked to the document chunks from which the summarizations, from which the entity property triplets and the entity relation triplets were determined, were generated,
generates a knowledge graph comprising nodes representing entities from the entity property triplets and entity relation triplets and edges representing the entity property triplets and the entity relation triplets;
receives a search query comprising keywords,
determines nodes and edges of the knowledge graph that comprise the entities, the entity property triplets and the entity relation triplets most similar to the keywords of the search query,
determines document chunks based on frequency counts of the number of times the document chunks are linked to the entities, entity property triplets, and relations triplets corresponding to the determined nodes and edges,
determines relevant entity property triplets and entity relation triplets by traversing the knowledge graph to a specified depth starting at the nodes in the determined nodes and edges, and
sends the determined document chunks and the relevant entity property triplets and entity relation triplets as a response to the received search query.

9. The computer-implemented system of claim 8 wherein an entity property triplet is linked to two or more document chunks, wherein a entity relation triplet is linked to two or more document chunks, and wherein an entity is linked to two or more document chunks.

10. The computer-implemented system of claim 8, wherein an edge representing one of the entity relation triplets connects two nodes representing entities wherein a first of the two nodes represents a source entity of the one of the entity relation triplets and a second of the two nodes represent a target entity of the one of the entity relation triplets.

11. The computer-implemented system of claim 8, wherein the processor generates a schema comprising the entity types, entity properties, relations, and relation properties by either selecting, with a large language model, from among the entity types, entity properties, relations and relation properties or using heuristics to select the most common of the entity types, entity properties, relations, and relation properties.

12. The computer-implemented system of claim 8, wherein the processor determines entity property triplets and entity relation triplets from the summarizations, wherein the entity property triplets and entity relation triplets are based on the schema and are linked to the document chunks from which the summarizations, from which the entity property triplets and entity relation triplets were determined, were generated by:
determining, with a large language model, entities, entity properties for the entities, relations, and relation properties for the relations from the summarizations;
generating possible entity property triplets from the entities and entity properties for the entities;
generating possible entity relation triplets from the relations and relation properties for the relations; and
selecting, using the large language model, complete possible entity property triplets to be the entity property triplets and complete possible entity relation triplets to be the entity relation triplets.

13. The computer-implemented system of claim 8, wherein the determined nodes and edges comprise N nodes and edges wherein N is a number less than total number of nodes and edges of the knowledge graph, and wherein the determined document chunks comprise K document chunks wherein K is a number less than the total number of the document chunks.

14. The computer-implemented system of claim 8, wherein the processor determines relevant entity property triplets and entity relation triplets by traversing the knowledge graph to a specified depth starting at the nodes in the determined nodes and edges by:
determining candidate triplets based on any entity property triplets and relations triplets represented by edges encountered during traversal of the knowledge graph; and
selecting, with a large language model, the relevant entity property triplets and entity relation triplets from among the candidate triplets.

15. A system comprising: one or more computers and one or more non-transitory storage devices storing instructions which are operable, when executed by the one or more computers, to cause the one or more computers to perform operations comprising:
generating document chunks from a group of documents;
generating summarizations from the document chunks;
generating entity types, entity properties, relations, and relation properties from a subset of the summarizations;
generating, by the computing device a schema comprising the entity types, entity properties, relations, and relation properties;
generating entity property triplets and entity relation triplets from the summarizations, wherein the entity property triplets and entity relation triplets are based on the schema and are linked to the document chunks from which the summarizations, from which the entity property triplets and the entity relation triplets were determined, were generated;
generating a knowledge graph comprising nodes representing entities from the entity property triplets and entity relation triplets and edges representing the entity property triplets and the entity relation triplets;
receiving a search query comprising keywords;
determining nodes and edges of the knowledge graph that comprise the entities, the entity property triplets and the entity relation triplets most similar to the keywords of the search query;
determining document chunks based on frequency counts of the number of times the document chunks are linked to the entities, entity property triplets, and relations triplets corresponding to the determined nodes and edges;
determining relevant entity property triplets and entity relation triplets by traversing the knowledge graph to a specified depth starting at the nodes in the determined nodes and edges; and
sending the determined document chunks and the relevant entity property triplets and entity relation triplets as a response to the received search query.

16. The system of claim 15, wherein an entity property triplet is linked to two or more document chunks, wherein a entity relation triplet is linked to two or more document chunks, and wherein an entity is linked to two or more document chunks.

17. The system of claim 15, wherein an edge representing one of the entity relation triplets connects two nodes representing entities wherein a first of the two nodes represents a source entity of the one of the entity relation triplets and a second of the two nodes represent a target entity of the one of the entity relation triplets.

18. The system of claim 17, wherein the instructions which are operable, when executed by the one or more computers, to cause the one or more computers to perform operations comprising generating, by the computing device a schema comprising the entity types, entity properties, relations, and relation properties further cause the one or more computers to perform operations comprising:
either selecting, with a large language model, from among the entity types, entity properties, relations and relation properties or using heuristics to select the most common of the entity types, entity properties, relations, and relation properties.

19. The system of claim 15, wherein the instructions which are operable, when executed by the one or more computers, to cause the one or more computers to perform operations comprising determining entity property triplets and entity relation triplets from the summarizations, wherein the entity property triplets and entity relation triplets are based on the schema and are linked to the document chunks from which the summarizations, from which the entity property triplets and entity relation triplets were determined, were generated further cause the one or more computers to perform operations comprising:
determining, with a large language model, entities, entity properties for the entities, relations, and relation properties for the relations from the summarizations;
generating possible entity property triplets from the entities and entity properties for the entities;
generating possible entity relation triplets from the relations and relation properties for the relations; and
selecting, using the large language model, complete possible entity property triplets to be the entity property triplets and complete possible entity relation triplets to be the entity relation triplets.

20. The system of claim 15, wherein the determined nodes and edges comprise N nodes and edges wherein N is a number less than total number of nodes and edges of the knowledge graph, and wherein the determined document chunks comprise K document chunks wherein K is a number less than the total number of the document chunks.
